(19) United States
(12) Patent Application Publication
(10) Pub. No.: US 2004/0019646 A1
(43) Pub. Date: Jan. 29, 2004

(54) Methods and systems for providing an on-line interaction manager

(76) Inventors: Monte Zweben, San Mateo, CA (US); Robert Lloyd Brown, Santa Clara, CA (US); Christopher B. Yeh, San Mateo, CA (US)

Correspondence Address: Finnegan, Henderson, Farabow,, Garrett & Dunner, L.L.P., 1300 I Street, N.W., Washington, DC, 20005-3315, US

(21) Appl. No.: 10/390,537

(22) Filed: Mar. 18, 2003

Related U.S. Application Data
(60) Provisional application No. 60/364,550, filed on Mar. 18, 2002.

(51) Int. Cl. G06F 15/16; H04M 3/00

(52) U.S. Cl. 709/206; 709/207; 379/265.09

(57) ABSTRACT

A system and method for personalizing content delivery to a customer over time and across channels. In one embodiment, based on a customer's demographics or behavioral characteristics, the method transmits an electronic mail message to a customer, wherein the message comprises a link to an Internet site. Next, the method waits for a specified amount of time and then transmits a bulk mail message to the customer, if the customer did not click on the link. The method then prompts a telemarketer to place a telephone call to the customer, if the customer did not respond to the bulk mail message within another specified amount of time.

### RELATED APPLICATIONS

This application claims priority from the following U.S. Provisional Application, the disclosure of which is incorporated by reference in its entirety for all purposes: U.S. Provisional Application Ser. No. 60/364,550 to Zweben et al., entitled, “System and Method for Providing an On-line Interaction Manager,” filed Mar. 18, 2002.

### DESCRIPTION OF THE INVENTION

1. Field of the Invention

The present invention relates to a message targeting system. More particularly, the present invention relates to a system and method for the automatic dispersion of information to a plurality of users over time and across different channels.

2. Background of the Invention

One problem that virtually every person who receives mail has experienced is receiving unsolicited advertisements or so-called “junk mail”. According to several authorities, there are over 123,000,000 postal addresses in the U.S. that receive mail from the U.S. Postal Service. Individually, an average of 41 pounds of mail are sent to every adult per year. About 44% goes unread directly into the garbage and about 93% of junk mail is ultimately discarded. Most people find junk mail to be time consuming and frustrating because they must sift through the unsolicited ads to get to important mail. In fact, the average American spends 8 full months of their life opening postal junk mail.

E-mail users who have e-mail accounts on the Internet suffer from the same dilemma, as unsolicited e-mail advertisements have become a highly popular method of attracting business. Recent figures indicate that there are over 14.7 million people in the US who access on-line services. Direct mailers and bulk mailers are now using the Internet to target e-mail addresses. Junk e-mail, or “spam”, is an annoyance because the recipient must open the mail, read it and then delete the message. In addition bulk e-mail consumes finite Internet resources by consuming memory space, access time and phone line usage.

Telemarketing, like bulk mailing and bulk e-mailing, has grown into a multi-billion dollar industry and is particularly frustrating because often telemarketers telephone prospective customers at inconvenient times about products and services that the customer often is not interested in purchasing.

The majority of unsolicited advertisements, via mail, e-mail, or telephone, stem from direct marketing groups who maintain vast databases containing thousands of individuals' personal identification (e.g., name, e-mail address, mailing address, telephone number, etc.) These direct mail marketing groups, or “warehouses”, indiscriminately sell customer lists to direct mail, e-mail and telephone advertisers, without determining whether the customer may actually be interested in the end product. Bulk mailers and direct market advertisers and telemarketers admit that there is very little success from bulk mailing/mass calling. Rather, the approach is to “blanket the market” with thousands of mailings knowing that the return is a very small percentage.

One solution to prevent bulk mail, bulk e-mail and unsolicited telephone calls is that a person can have his or her information deleted from the database of a bulk mailer or direct advertiser. However, in doing so, a person may inadvertently forego an opportunity to purchase merchandise and services of interest. Furthermore, there are approximately 4200 such warehouses, thus, it would be virtually impossible for an individual to access all of the warehouses that contain personal data that is sold to, or used by, bulk mailers, bulk e-mailers and direct telemarketers.

Another solution to prevent bulk mail, bulk e-mail and unsolicited telephone calls is to intelligently direct such unsolicited contacts to users who are more likely to purchase the service or product. A user's likelihood for purchasing a product could be predicted from several factors including demographics, Internet surfing habits, hobbies, etc. For example, a user can access the Internet and perform a search in an attempt to identify a particular product or service of interest. Several search sites on the Internet, for example, Yahoo, AltaVista, Netscape, etc. are available to users. However, such systems typically require the user to spend valuable time modifying search parameters to retrieve desired search results. Moreover, such searches are typically very broad in scope (e.g., vacation sites, books, clothes, etc.) which usually does not give enough insight into the specific service or merchandise sought.

Yet another method to prevent unwanted bulk mail, bulk e-mail and unsolicited telephone calls is to only send these type of messages when a customer requests them or takes a specific action that makes them a good candidate for the communication.

Thus, there exists a need for a system that will direct a reduced number of bulk mail, e-mail and telemarketer calls to a customer without unnecessarily limiting the customer's access to the entire community of direct mailers, direct e-mailers and telemarketers.

Another need exists for a system and method that intelligently routes subsequent deliveries of bulk mail, bulk e-mail, and telemarketer calls based on a user's actions (e.g., purchasing habits), demographics and communicated areas of preference.

### SUMMARY OF THE INVENTION

Systems and methods consistent with the present invention satisfy the above-described need by providing a system and method for personalizing content delivery to customers. In one embodiment, the method includes the steps of: transmitting an electronic mail message to a customer, said message comprising a link to a website, wherein transmission of said electronic mail message is prompted by an event unique to the customer; transmitting a bulk mail message to the customer, if the customer did not click on the link to the second website; and placing a telephone call to the customer, if the customer did not respond to the bulk mail message.

To facilitate an understanding of the present invention, it is described hereinafter with reference to specific implementations thereof. For example, the software programs that underlie the invention can be coded in different languages, for use with different platforms. In the description that follows, examples of the invention are described in the context of web sites that employ Java Server Pages (JSP). It will be appreciated, however, that the principles that underlie the invention can be implemented with other types of computer software technologies as well.

Additional benefits of the invention will be set forth in part in the description which follows, and in part will be obvious from the description, or may be learned by practice of the invention. The benefits of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate exemplary embodiments of the present invention and together with the description, serve to explain the principles of the invention. In the drawings,

FIG. 1 is a block diagram depicting an illustrative system in which the present invention may be practiced;

FIG. 2 is depiction of a computer system in accordance with an exemplary embodiment of the present invention;

FIG. 3 is a flow chart depicting the steps performed by the present invention in the information retrieval mode;

FIG. 4 is a flow chart depicting the steps performed by the present invention in the information dissemination mode (batch processing);

FIG. 5 is a flow chart depicting the steps performed by the present invention in the information dissemination mode (individual processing); and

FIGS. 6a-6m depict sample dialogs that may be implemented by an embodiment of the present invention.

### DETAILED DESCRIPTION

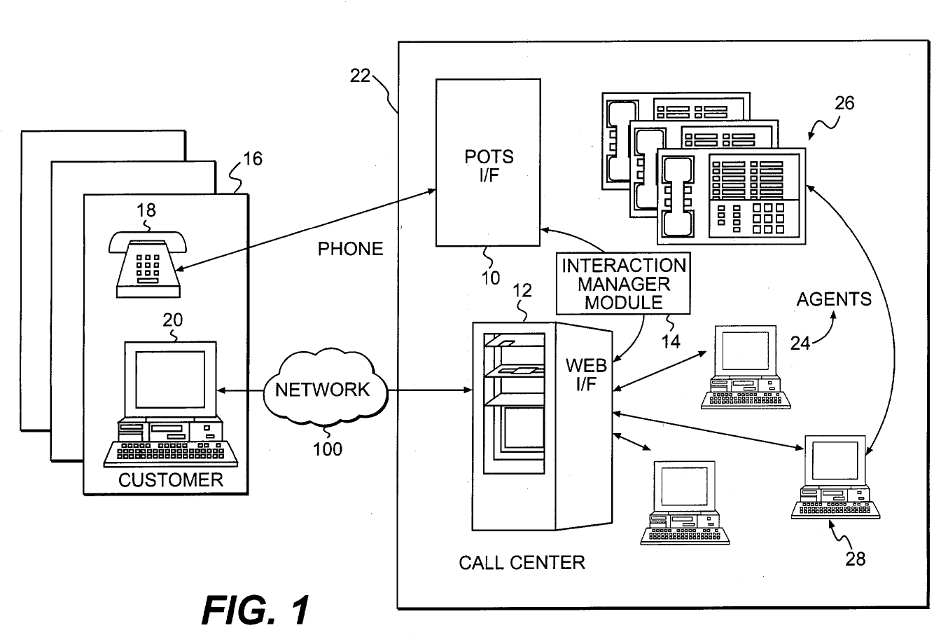

A general depiction of a networked computer system in which the present invention can be implemented is illustrated in FIG. 1. In the following detailed description of a first embodiment, reference is made to the accompanying drawings that form a part thereof, and in which is shown by way of illustration a specific embodiment in which the invention may be practiced. This embodiment is described in sufficient detail to enable those skilled in the art to practice the invention and it is to be understood that other embodiments may be utilized and that structural changes may be made without departing from the scope of the present invention. The following detailed description is, therefore, not to be taken in a limited sense.

Turning first to the nomenclature of the specification, the detailed description which follows is represented largely in terms of processes and symbolic representations of operations performed by conventional computer components, including a central processing unit (CPU), memory storage devices for the CPU, and connected pixel-oriented display devices. These operations include the manipulation of data bits by the CPU and the maintenance of these bits within data structures residing in one or more of the memory storage devices. Such data structures impose a physical organization upon the collection of data bits stored within computer memory and represent specific electrical or magnetic elements. These symbolic representations are the means used by those skilled in the art of computer programming and computer construction to most effectively convey teachings and discoveries to others skilled in the art.

For the purposes of this discussion, a process is generally conceived to be a sequence of computer-executed steps leading to a desired result. These steps generally require logical manipulations of physical quantities. Usually, though not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, terms, objects, numbers, records, files or the like. It should be kept in mind, however, that these and similar terms should be associated with appropriate physical quantities for computer operations, and that these terms are merely conventional labels applied to physical quantities that exist within and during operation of the computer.

It should also be understood that manipulations within the computer are often referred to in terms such as adding, comparing, moving, etc. which are often associated with manual operations performed by a human operator. It must be understood that no such involvement of a human operator is necessary or even desirable in the present invention. The operations described herein are machine operations performed in conjunction with a human operator or customer who interacts with the computer. The machines used for performing the operation of the present invention include general purpose digital computers or other similar computing devices.

In addition, it should be understood that the programs, processes, methods, etc. described herein are not related or limited to any particular computer or apparatus. Rather, various types of general purpose machines may be used with programs constructed in accordance with the teachings described herein. Similarly, it may prove advantageous to construct specialized apparatus to perform the method steps described herein by way of dedicated computer systems with hard-wired logic or programs stored in nonvolatile memory, such as read only memory.

The operating environment in which the present invention is used encompasses general distributed computing systems wherein general purpose computers, workstations, or personal computers are connected via communication links of various types. In a client server arrangement, programs and data, many in the form of objects, are made available by various members of the system.

Referring now to the drawings, in which like numerals represent like elements throughout the several figures, the present invention will be described.

FIG. 1 depicts a representative network environment 1 in which the system and method for providing an online interaction manager may be practiced. As shown in FIG. 1, environment 1 is comprised of at least one customer site 16 and at least one call center 22. Customer site 16 includes a telephone 18 for standard-type voice communication, and a computer 20 for network communication. Other communication types are possible and can be suitable in other embodiments of the invention. It will be apparent that present, and future communication types can be substituted, or added to, the communication types discussed herein with many of the same mechanisms and features that apply to the listed communication types also being applicable to communication types not specifically discussed. Call center 22 includes a plain old telephone system (POTS) interface 10, a Web interface 12, a plurality of telephones 26, a plurality of computers 28, and an interaction manager module (IMM) 14. POTS Interface 10 provides an interface between call center telephones 26 and one or more customer telephones 18, and Web interface 12 provides an interface between call center computers 28 and customer computers 20 over a network 100. Agents 24 in call center 22 use telephones 26 and computers 28 to interface with customers at customer site 16. When communicating with one or more customer sites 16, call center 22 utilizes IMM 14 to coordinate and control communication functions provided by POTS Interface 10 and Web Interface 12. The coordination of these systems allows human agents 24 to identify marketing prospects and initiate contact via telephone, e-mail, or bulk mail. Additionally, IMM 14 provides automated information through the use of a knowledge base or other data exchange, such that the customer may be provided information without requiring the participation of a human agent. As discussed below, IMM 14, along with other processes, devices, etc., as described, serve to perform the features and functions of the present invention.

Network 100 can be any network topology commonly known by those of ordinary skill in the art, such as Ethernet, a LAN, WAN, ATM network, or Internet. Network 100 may be implemented using any one or a combination of public packet switched network topologies, such as IEEE 802.3 Ethernet, IEEE 802.5 Token Ring, International Telecommunications Union (ITU) X.25, or serial (SLIP) protocols, for example. Network 100 may be the Internet using the World Wide Web (WWW or simply “Web”) protocol defined, in part, by hyper-text markup language (HTML) pages. Communication over network 100 may be via web pages, Internet Protocol (IP) voice communication such as that defined by ITU recommendation H.323 (February 1998)), packet-based multimedia communications systems, web services, MQ series, chat, video and e-mail. Any number or combination of these communication types may be used in different configurations of the present invention.

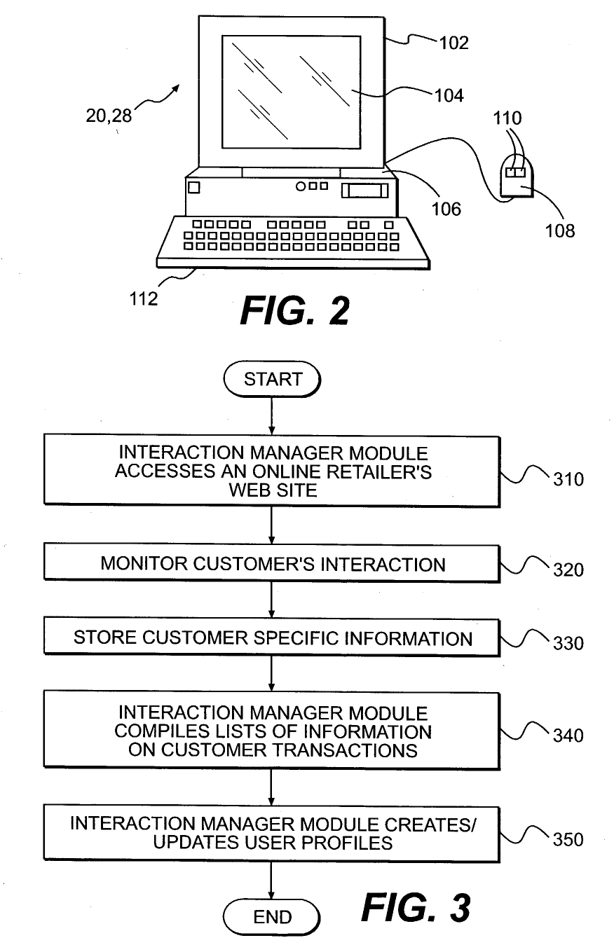

Referring to FIG. 2, there is shown a computer system (20 and 28) including a display 102 having a display screen 104. Cabinet 106 houses standard computer components (not shown) such as a disk drive, CDROM drive, display adapter, network card, random access memory (RAM), central processing unit (CPU), and other components, subsystems and devices. User input devices such as mouse 108 having buttons 110, and keyboard 112 are also shown. Other user input devices such as a trackball, touch-screen, digitizing tablet, etc. can be used. In general, computer system (20 and 28) is illustrative of one type of computer system, such as a desktop computer, suitable for use with the present invention. Computer systems (20 and 28) may be configured with many different hardware components and may be made in many dimensions and styles (e.g., laptop, handheld, wireless, server, workstation, mainframe, etc.) without departing from the present invention. In an exemplary embodiment of the present invention, computer 20 may be web-enabled wireless telephones such as for example cellular CDMA, TDMA, or GSM telephones that support the Wireless Access Protocol (“WAP”) or i-Mode data access protocols for displaying web application information. Alternatively, computer 20 may be wireless Internet-connected personal digital assistants (“PDA”), such as, for example, the Palm VIIx from Palm™ Inc. Computer 20 may also be personal computers capable of accessing network 100 via a protocol such as the Bluetooth protocol. Any hardware platform suitable for performing the processing described herein is suitable for use with the present invention.

It should be understood that IMM 14, in its broadest sense, operates in an information retrieval mode and an information dispersal mode. When operating in the information retrieval mode, IMM 14 may monitor one or more web sites to identify customers, create/maintain customer profiles, and catalog recent purchases by the customers. For example, IMM 14, through Web interface 12, may monitor visitors to an online retailer's web site and record information about the customer's browsing habits while at the site. IMM14 may also monitor the activities surrounding the creation and progress toward completion of an online gift registry. That is, IMM 14 may monitor the gifts selected by the registrants, the progress and order of gifts purchased, and the date of the celebratory event (i.e., wedding, newborn, etc.) In some systems, the initial information requested is a login name and password. A name may be required in applications where it is desired to keep track of customers' records and to be able to retrieve past records associated with a customer. A password may be necessary where security is a concern, or where services are restricted to specific users. More specifically, IMM 14 may record the customer's personal identification data (e.g., name, address, e-mail address, phone number, etc.), purchase information, and browsed pages. Prior to, or shortly after storing the information, IMM 14 may aggregate the information into categories that will assist IMM 14 in later identifying potential recipients of marketing mailings, e-mailings, and telemarketer calls.

In the information dispersal mode, IMM 14 identifies one or more offers and/or messages and then selects a plurality of customers to receive the marketing material (via mailings, e-mailings, personalized content and telemarketer calls) based on recent purchases and non-purchases. In the gift registry context, IMM 14 may monitor the period of time remaining before/after the celebratory event and then offer the registrants a special discount on the unsold items remaining on the list. In a retail setting, IMM 14 may identify an item to cross-sell to a customer based on a previous purchase by the customer, and then offer the customer a discount, provided a purchase is made within a predetermined period of time. These mailings and calls may be generated by a personal computer, e-mail terminal, agent 24, interactive voice response (IVR) system (not shown), etc.

Referring now to FIG. 3, there is shown a flow chart depicting the steps performed by IMM 14 when in the information retrieval mode. As shown, processing begins in step 310 when IMM 14 accesses an online retailer's web site or signs up for an online gift registry. While this specification describes the subject invention from the perspective of an online retailer, it is important to note that any online web site may be used. For example, IMM 14 may access a site operated by a financial services company, or an online job searcher, etc. In the financial services context, IMM 14 may notify a customer when a security reaches a predetermined price, or when an account accrues a predetermined amount.

Throughout the customer's interaction at the web site, their actions and responses are captured (step 320). Next, IMM 14 stores customer-specific information in a data warehouse (step 330). Processing then flows to step 340 where the interaction manager module compiles lists of information on the customer transactions. IMM 14 may store lists of online customers who browsed specific pages, purchased specific items of merchandise, asked specific questions, etc. IMM 14 may also store information inputted by online customers (e.g., birthdates, anniversary dates, etc.) IMM 14 then creates/updates a customer profile associated with one or more of the online customers (step 350). For example, if the online customer purchased children books, IMM 14 may update the customer's profile to indicate that the customer has children or is likely to have children. Similarly, if the online customer browsed a site that sells pet supplies, IMM 14 may update the customer's profile to indicate that the customer has a pet. As another example, IMM 14 may update the customer's profile to indicate that the customer is a registrant for an online gift registry and that the online registry identified a greater than average or a less than average quantity of gifts and/or a higher or lower average cost of gifts. In one embodiment, this update presents itself as a score or string that indicates that that the customer falls into one or more groups. Once the customer profile has been compiled, processing terminates.

At the completion of information retrieval, a plurality of customer profiles based on the customer's actions at one or more web sites is created. When IMM 14 is provided with a marketing campaign (e.g., sell caller ID subscriptions from September 1-September30), it may then begin information dispersal. In other words, IMM 14 may then identify those customers who are more likely to purchase the product or service offered and target advertisements/information to them. IMM 14 may also monitor the progress of a customer's gift registry to determine whether the customer should be offered an opportunity to add gifts to the registry, whether the customer should be offered a discount on the items remaining in the gift registry, and whether to suggest cross-sells to the customer based on items purchased from the gift registry. IMM 14 also monitors previous attempts to market to a particular customer to minimize repetitive marketing, and to take advantage of successful marketing tactics. For example, if a customer's profile indicates that he/she is more likely to respond affirmatively to an e-mail solicitation rather than a bulk mail solicitation, IMM will increase its frequency of e-mail solicitations to the customer and decrease the frequency of bulk mail and telemarketing solicitations.

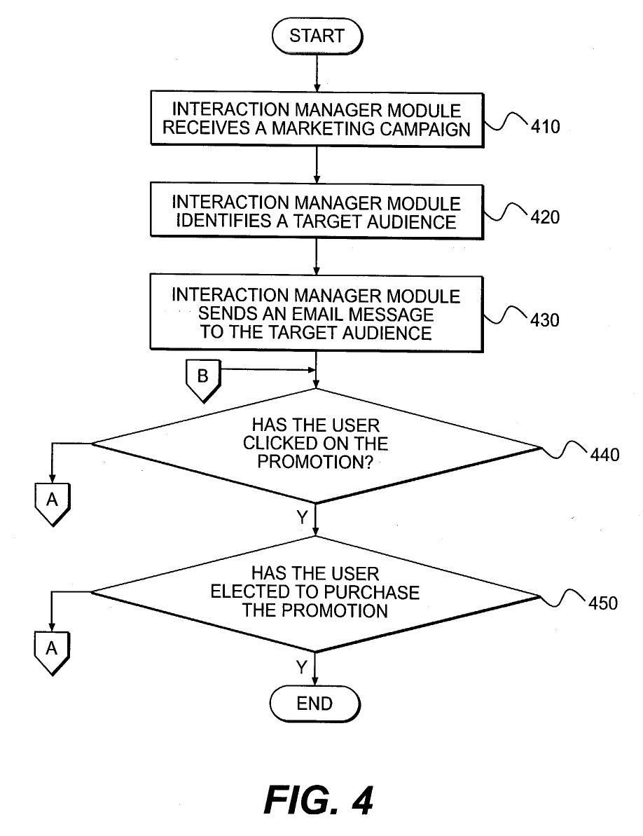

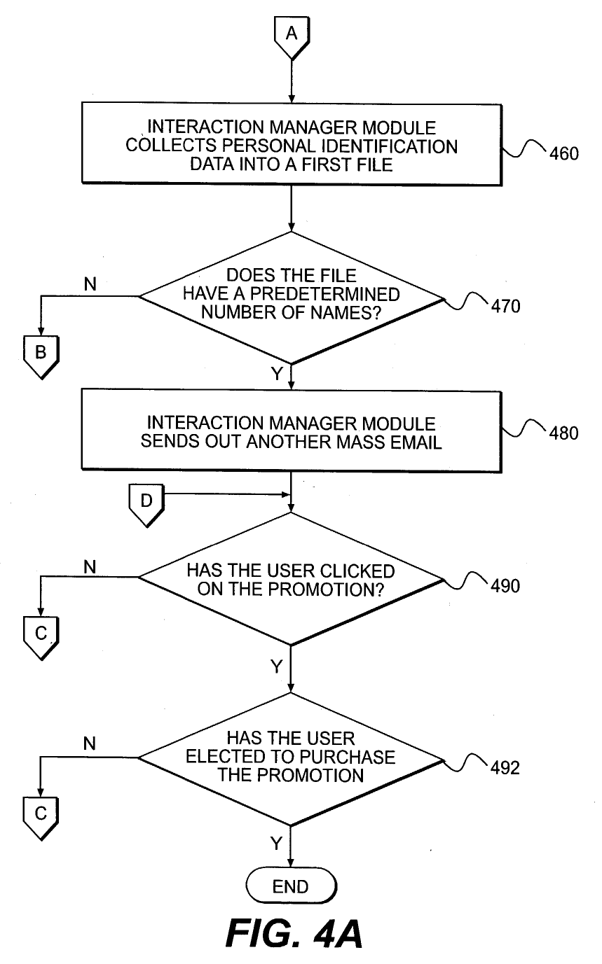

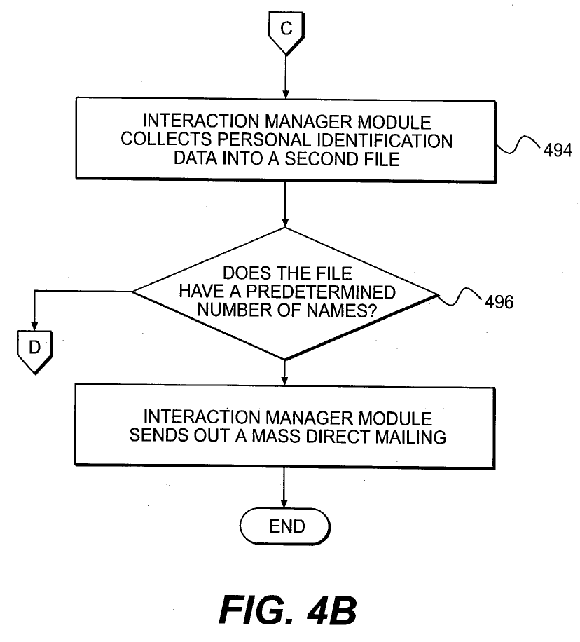

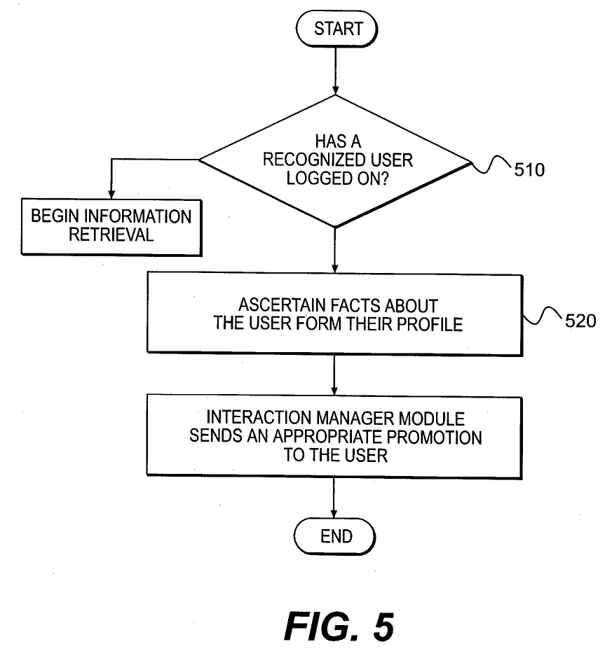

When IMM 14 is in the information dispersal mode, it may process transactions individually or in batch. Referring to FIG. 4, there is shown a flowchart depicting the steps performed by the IMM as it processes batch transactions (FIG. 5 reveals the steps performed when the IMM processes individual interactions). When processing batch interactions, IMM 14, first receives a marketing campaign (step 410). The marketing campaign consists of a period of time for the campaign, and one or more messages with associated offers. The marketing campaign may either be internally generated or transmitted to IMM 14 from an external source (i.e., another retailer, financial analyst, etc.) Once it has the marketing campaign, IMM 14 then identifies a target audience (step 420). This target audience may be identified from lists created by IMM 14 when in the information retrieval mode, or the target audience may simply be provided to IMM 14 from an outside data source. In any event, the list identified by IMM 14 is based on specific information about the target audience (demographics, purchasing history, etc.) Once the target audience is identified, IMM 14 then sends an e-mail message to each member of the target audience (step 430). The e-mail messages may be transmitted nearly simultaneously or they may be transmitted over an extended period of time. In one embodiment, the e-mail message contains an HTTP link to an online promotion for a product or service. When the customer opens the e-mail message, IMM 14 determines whether the customer has clicked on the promotion (step 440). If the customer has clicked on the promotion, processing flows to step 450 where IMM 14 determines whether the customer elected to buy the promotion. If the customer has not clicked on the promotion, processing flows to step 450. If the customer elects to buy the promotion, processing may terminate or IMM 14 may send the customer a customer survey that requests feedback about the customer's experience. If the customer does not buy the promotion, processing flows to step 460 where IMM 14 collects the customer personal identification data into a file. When the file has a predetermined number of names in the file (step 470), IMM 14 sends out another mass e-mailing (step 480). If there are not a predetermined number of names in the file, processing returns to step 440 where IMM 14 determines whether the next customer has clicked on the promotion. IMM 14 may alternatively send out a mass mailing or begin a telemarketing campaign when a predetermined number of names are in the file. IMM 14 then determines whether the customer has elected to click on the promotion (step 490) or elected to buy the promotion (step 492). If the customer has elected to buy the promotion, processing terminates. If the customer has once again refused to click on or buy the promotion, processing flows to step 494 where IMM 14 collects the personal information in a second file. Once that file reaches a predetermined size (step 496), IMM 14 sends out a mass direct mailing to the people in the file (step 498). IMM 14 may alternatively send out another e-mail to the customers in the list, or begin a telemarketing campaign. Processing then terminates. While the previous description provides that subsequent messages will be transmitted to a customer if the customer does not respond to one or more previous messages, it is understood that subsequent messages could be transmitted to the customer, whether or not the customer responds to the previous message.

When processing individual transactions, IMM 14 first determines whether a recognized customer has logged on (step 510). A recognized customer is one who has a previously-stored profile. Once a recognized customer has logged on, processing flows to step 520 where IMM 14 ascertains one or more facts about the customer from the profile. For example, IMM 14 may determine that the customer has recently purchased several books by the same author, enjoys skydiving, and has two children. Based on the information learned, IMM 14 will then send one of a plurality of promotions for consideration by the customer. In one embodiment, the promotion selected will be a promotion that is related to one or more facts learned from the customer profile. In a second embodiment, the promotion selected to be displayed to the customer will be a promotion that is related to a promotion previously displayed to the customer. In a third embodiment, the promotion selected to be displayed to the customer will be a promotion that is related to one or more Web sites previously displayed by the customer. For example, if it is known that customers who view pages related to a first product are usually also interested in other related products, those related products may be promoted to the customer. IMM 14 may select the particular format for the promotion based on a historical success rate with the customer. For example, if a customer more often responds positively when he/she receives a mailed promotion than an e-mailed promotion, IMM 14 may elect to send the promotion via the mail. If, on the other hand, the customer more often responds positively when he/she receives a telephone call from a telemarketer, IMM 14 places the information in a queue associated with POTS interface 10 for resolution by an agent 24.

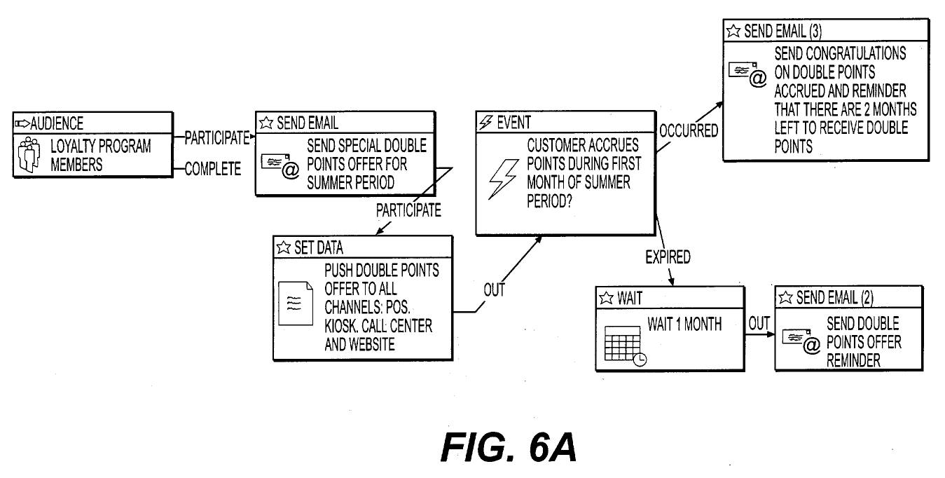

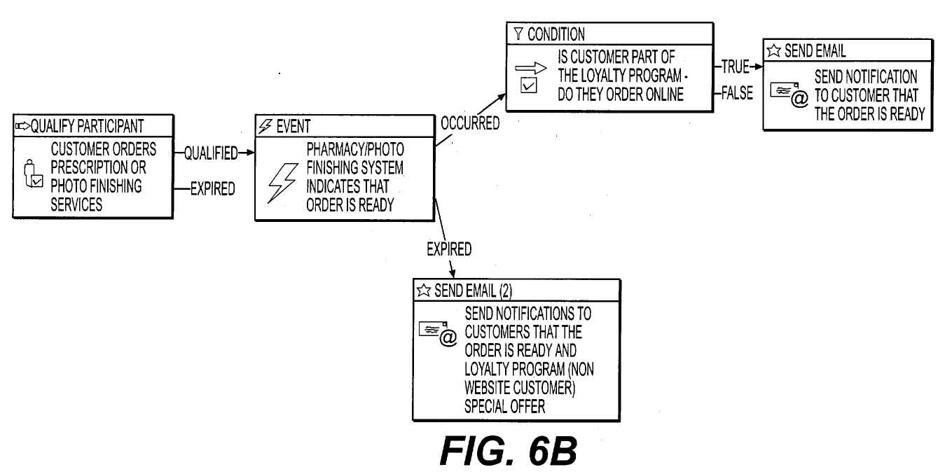

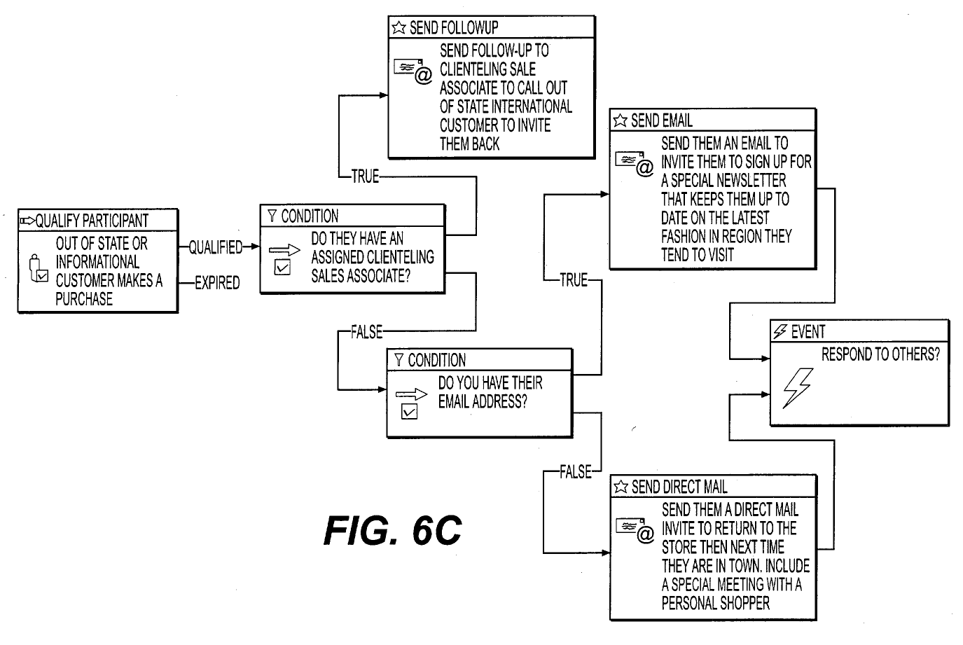

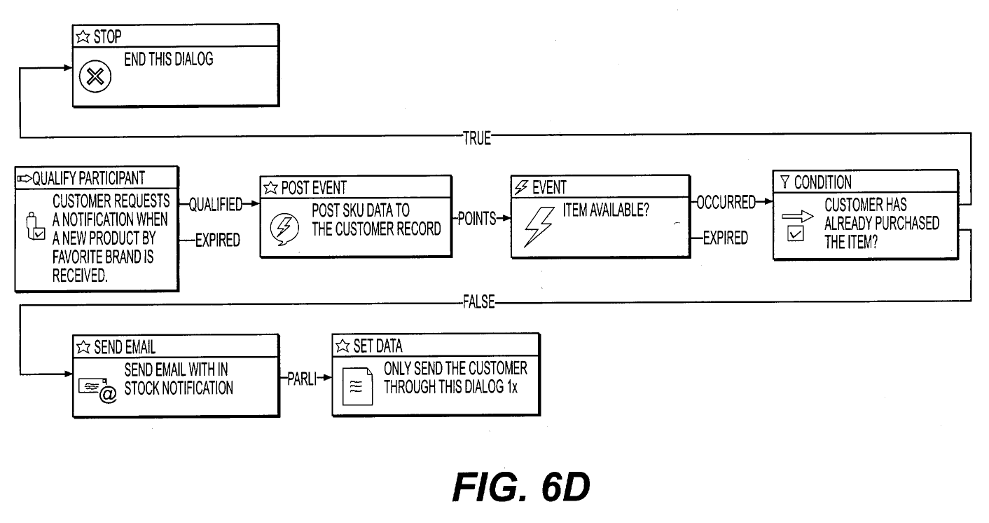

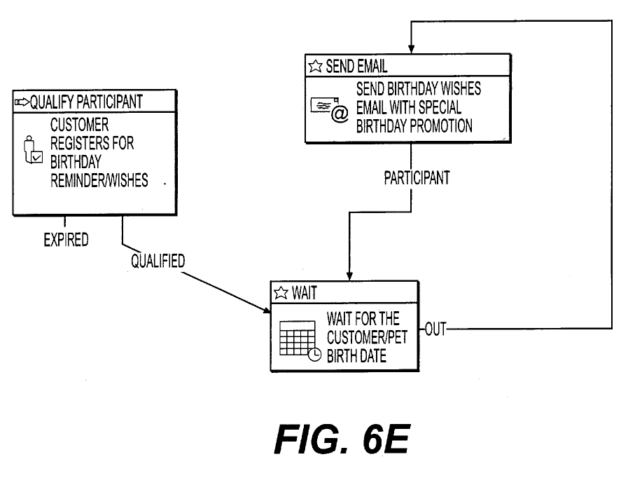

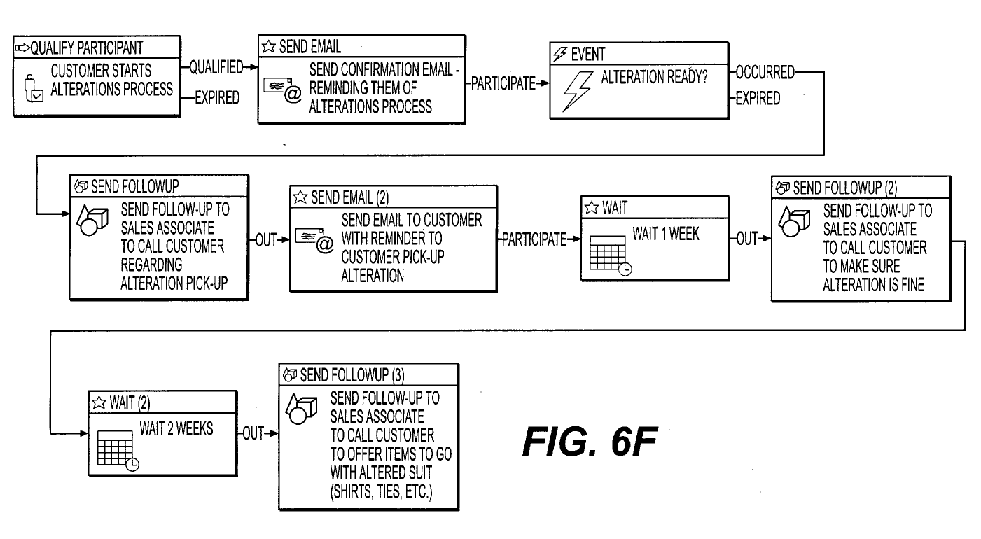

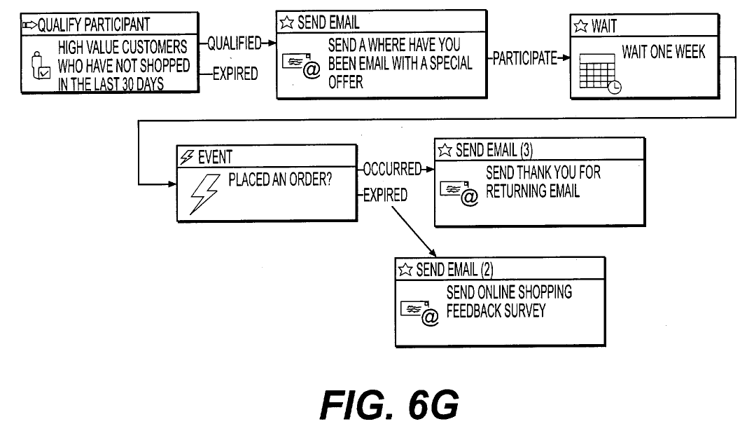

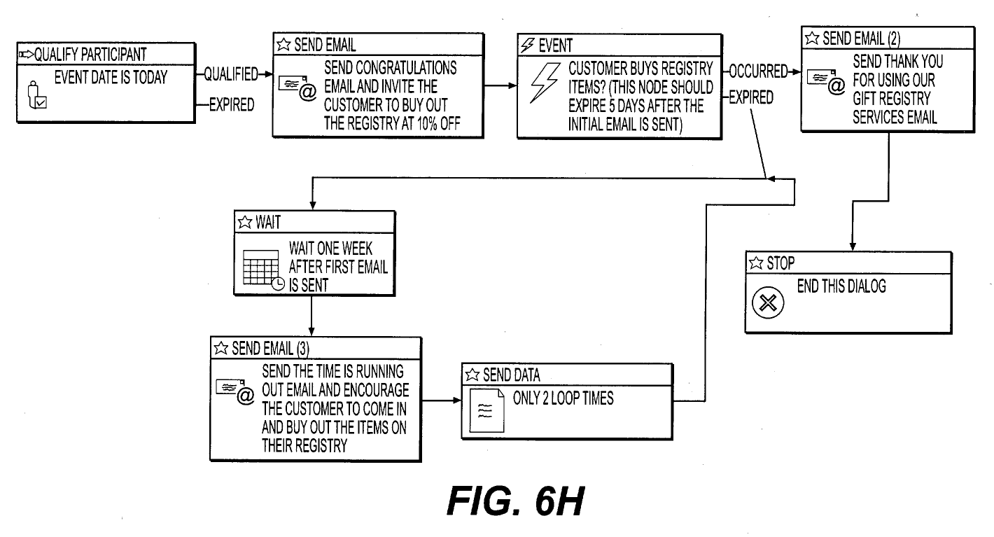

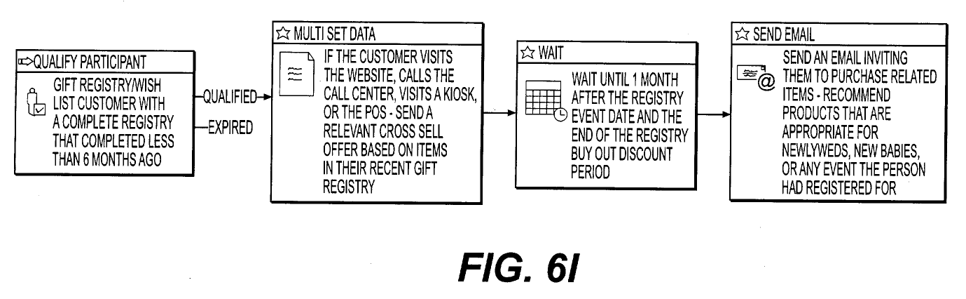

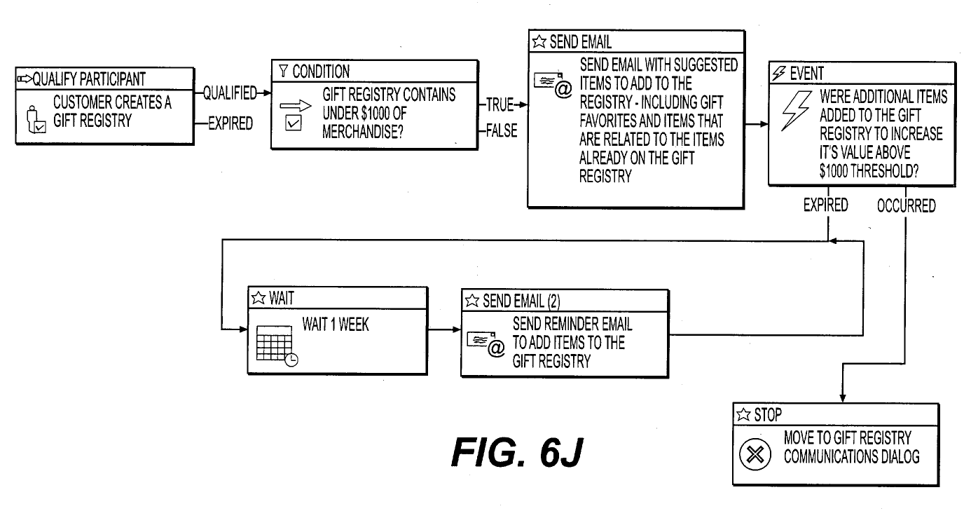

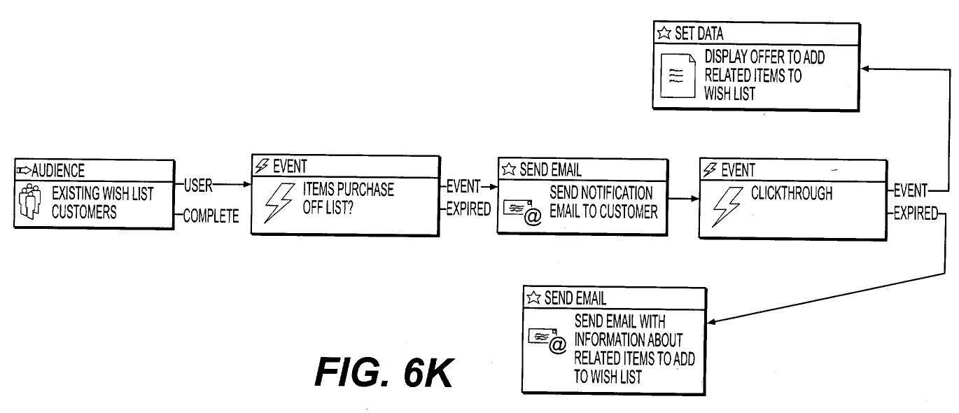

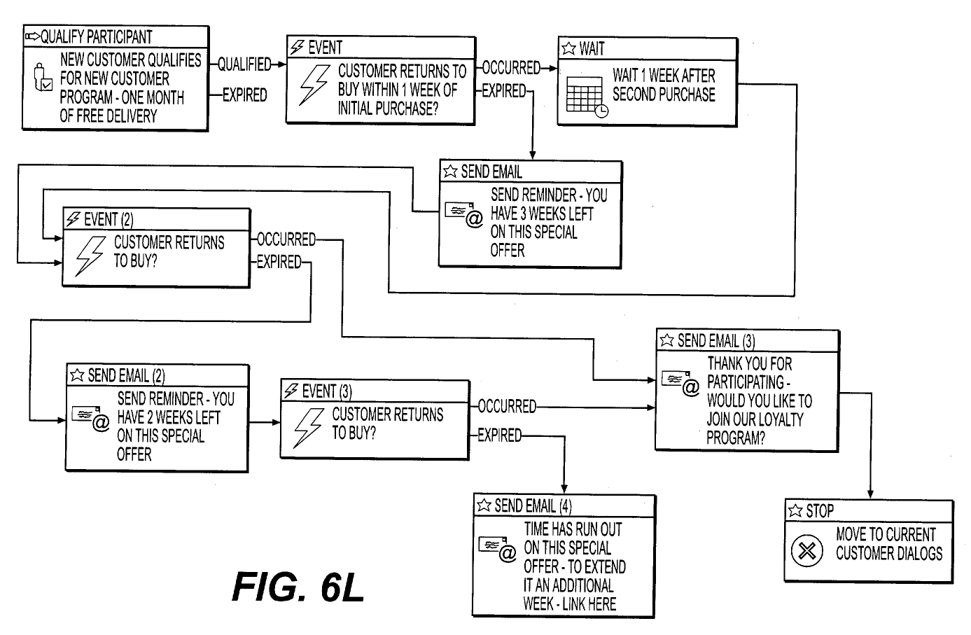

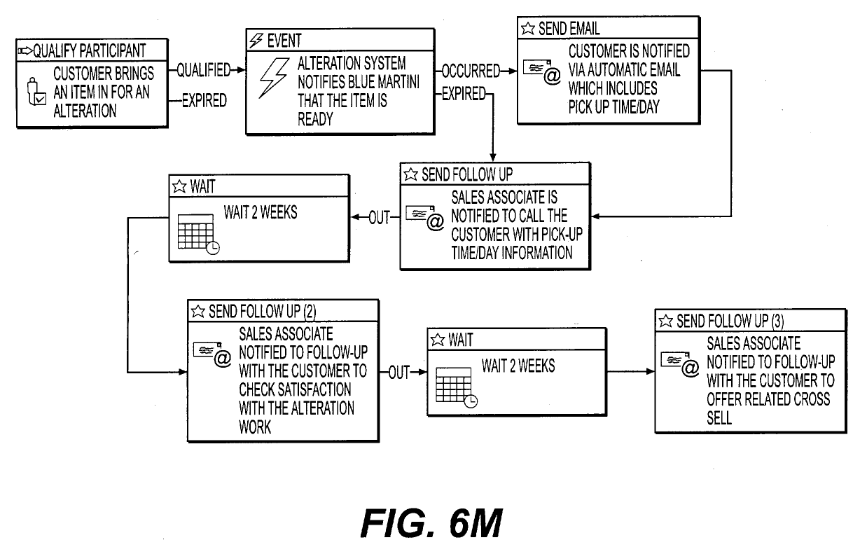

Turning now to FIGS. 6a-6m, there are shown several dialogs that depict individual transactions that may be processed by IMM 14. While many of the dialogs depict multiple emails being transmitted to a customer, one of skill in the art will appreciate that instead of emails, IMM 14 may cause direct mailings or telemarketer contacts to be made without departing from the spirit and scope of the present invention.

From the foregoing description, it will be appreciated that the present invention provides an efficient system and method for providing an on-line interaction manager. The present invention has been described in relation to particular embodiments which are intended in all respects to be illustrative rather than restrictive. Those skilled in the art will appreciate that many different combinations of hardware will be suitable for practicing the present invention. Many commercially available substitutes, each having somewhat different cost and performance characteristics, exist for each of the components described above.

The method of the present invention may conveniently be implemented in program modules that are based upon the flow charts in FIGS. 4 and 5. No particular programming language has been indicated for carrying out the various procedures described above because it is considered that the operations, steps and procedures described above and illustrated in the accompanying drawings are sufficiently disclosed to permit one of ordinary skill in the art to practice the instant invention. Moreover, there are many computers and operating systems which may be used in practicing the instant invention and therefore no detailed computer program could be provided which would be applicable to these many different systems. Each customer of a particular computer will be aware of the language and tools which are most useful for that customer's needs and purposes.

Alternative embodiments will become apparent to those skilled in the art to which the present invention pertains without departing from its spirit and scope. Accordingly, the scope of the present invention is defined by the appended claims rather than the foregoing description.

What is claimed is:

1. A method for personalizing content delivery to a customer, the method comprising:
transmitting an electronic mail message to a customer, said message comprising a link to a website, wherein transmission of said electronic mail message is prompted by an event unique to the customer;
transmitting a bulk mail message to the customer, if the customer did not click on the link to the second website; and
placing a telephone call to the customer, if the customer did not respond to the bulk mail message.

2. The method of claim 1, wherein the bulk mail message is different from the electronic mail message.

3. The method of claim 1, further comprising transmitting content and offers from at least a first website to said customer.

4. The method of claim 1, wherein the event unique to the customer is the customer's birthday.

5. The method of claim 1, wherein the event unique to the customer is a date and time that the customer purchased a predetermined product.

6. The method of claim 1, wherein the event unique to the customer is a date and time that the customer registered with a gift registry.

7. The method of claim 6, wherein the event unique to the customer is a date and time that a predetermined number of gifts are purchased from the customer's gift registry.

8. A method for personalizing content delivery to a customer, the method comprising:
transmitting a message in a first format over a first network to a customer, said message comprising a link to a site on the network;
transmitting the message in a second format over a second network to a customer, if the customer did not visit the site; and
placing a telephone call to the customer, if the customer did not respond to the message transmitted over the second network.

9. A method for personalizing content delivery to a customer, the method comprising:
creating a profile of a customer based on the customer's purchasing history, said profile comprising a plurality of message formats delivered to the customer and a frequency of customer responses to each of the plurality of message formats;
transmitting a message to the customer in a first format, said first message format historically resulting in a high frequency of responses from the customer;
transmitting the message to the customer in a second format, said message format having a lower frequency of responses from the customer than the first message; and
placing a telephone call to the customer, if the customer did not respond to the message transmitted in the second format.

10. The method of claim 9, wherein the customer responses are positive customer responses.

11. The method of claim 9, wherein creating a profile further comprises:
capturing a customer id of a customer;
associating at least one web site visited by the customer with the customer;
storing a format of at least one message delivered to the customer; and
recording a customer response to the message.

12. A method for personalizing content delivery to a customer, the method comprising:
transmitting an electronic mail message to a plurality of customers, said message comprising a link to an Internet site;
storing a customer's name in a first file, if the customer did not click on the link;
transmitting a bulk mail message to the customer in the first file, when the first file is a predetermined size;
storing the customer's name in a second file, if a customer did not respond to the bulk mail message; and
placing a telephone call to the customer in the second file, when the second file is a predetermined size.

13. The method of claim 12, wherein the bulk mail message is a different message from the electronic mail message.
